(19) United States
(12) Patent Application Publication
(10) Pub. No.: US 2011/0077938 A1
(43) Pub. Date: Mar. 31, 2011

(54) DATA REPRODUCTION METHOD AND DATA REPRODUCTION APPARATUS

(75) Inventors: Atsutoshi Naraki, Kanagawa (JP); Yuuichirou Nakamura, Kanagawa (JP); Kaori Tajima, Kanagawa (JP); Satoshi Sasaki, Chiba (JP); Katsuhiro Okawara, Kanagawa (JP); Hiroshi Kamiki, Kanagawa (JP)

(73) Assignee: PANASONIC CORPORATION, Osaka (JP)

(21) Appl. No.: 12/962,337

(22) Filed: Dec. 7, 2010

Related U.S. Application Data
(63) Continuation of application No. PCT/JP09/01805, filed on Apr. 20, 2009.

(30) Foreign Application Priority Data
Jun. 9, 2008 (JP) 2008-150699

(51) Int. Cl. G10L 19/00

(52) U.S. Cl. 704/201; 704/E19.001

(57) ABSTRACT

A reproduction apparatus that reproduces compressed audio data recorded in a recording medium inserts dummy data between data to be concatenated and reproduces the data when performing a specific reproduction of the data obtained by concatenating data which are discontinuously read from the recording medium.

### TECHNICAL FIELD

The present invention relates to a data reproduction method and a data reproduction apparatus for discontinuously reading data from a recording medium which stores compressed audio data therein and performing specific reproduction of the read data.

### BACKGROUND ART

Some of data reproduction apparatus that reproduce audio data which are highly compressed by an MP3 (MPEG1 Audio Layer III) format can perform specific reproduction, such as double speed reproduction. FIG. 4 is a diagram showing a data structure of the MP3 audio data. As shown in FIG. 4, the MP3 audio data 1 include frames 2 that act as unit data configuring the MP3 audio data 1. When the data reproduction apparatus performs normal reproduction of the MP3 audio data, the data reproduction apparatus sequentially performs reproduction processing of all of the frames enclosed in the MP3 audio data.

FIG. 5 is a diagram for describing a structure of reproduction data employed when a related art data reproduction apparatus performs fast-forward reproduction or fast-backward reproduction (hereinafter called “specific reproduction”) of the MP3 audio data. As shown in FIG. 5, when the data reproduction apparatus performs the specific reproduction of the MP3 audio data 1, the data reproduction apparatus extracts data from the MP3 audio data 1 at given intervals and on a per-sector basis and reproduces extraction data 3, extraction data 4, and extraction data 5 in this order.

When such specific reproduction is performed, discontinuously concatenated data is existed at a boundary between the data extracted on a per-sector basis. However, the discontinuously concatenated data includes incomplete segmented frame data. Therefore, the discontinuously concatenated data is determined as error data and is not output as sound. However, when the data extracted on the per-sector basis are concatenated in a state that a trailing end of a frame and a leading end of a frame are accidentally coincided with a boundary between sectors, it may not be determined that the concatenated data is error data, so that the discontinuous frame is reproduced. Therefore, noise arises at the boundary of the concatenated extraction data.

FIG. 6 is a diagram showing example boundary data which are not determined as error data in an area where the data extracted on a per-sector basis are concatenated. As shown in FIG. 6, when a trailing end of a frame M coincides with a trailing end of the extraction data 3 and the head of a frame N coincides with a leading end of the extraction data 4, boundary data 6 in which the frame M is concatenated to the frame N is recognized as complete frame data. Hence, the data reproduction apparatus does not determine the boundary data 6 as error data.

To solve the problem, according to the technique disclosed in Patent Document 1, data are discontinuously extracted so that a trailing end of a frame and a leading end of a frame do not overlap each other at a concatenation boundary between the extracted data, whereby boundary data are forcefully detected as an error such as incomplete frame data, and the boundary data are not reproduced.

### RELATED ART DOCUMENT

Patent Document
Patent Document 1: JP-A-2003-317391

### DISCLOSURE OF THE INVENTION

### Problem that the Invention is to Solve

However, when a data size of the boundary data 6 accidentally matches a size of one frame as shown in FIG. 7(a) or when a data sequence (a pseudo sync word) that have the same pattern as that of a sync word is accidentally present in the boundary data 6 as shown in FIG. 7(b), the boundary data 6 to be originally detected as an error cannot be recognized as the error, even by applying the technique described in Patent Document 1. As a consequence, noise occurs.

An object of the present invention is to provide a data reproduction method and a data reproduction apparatus that can completely avoid occurrence of noise during specific reproduction of compressed audio data read from a recording medium, which would otherwise be caused by boundary data obtained by concatenating data discontinuously read from the recording medium.

### Means for Solving the Problem

The present invention provides a data reproduction method including:

reading compressed audio data recorded in a recording medium discontinuously;

inserting dummy data between the read compressed audio data;

concatenating the dummy data and the read compressed audio data to generate data; and

performing specific reproduction of the generated data.

According to the data reproduction method, the specific reproduction is a fast-forward reproduction or a fast-backward reproduction.

According to the data reproduction method, the dummy data have a data size which is equal to or greater than a size of one frame in standards of the compressed audio data.

According to the data reproduction method, the dummy data have an arbitrary character string.

The present invention provides a data reproduction apparatus including: a data reading unit configured to read compressed audio data recorded in a recording medium; and a data insertion unit configured to insert dummy data between data to be concatenated and reproduces the data when performing a specific reproduction of data obtained by concatenating the data which are discontinuously read from the recording medium.

According to the data reproduction apparatus, the specific reproduction is a fast-forward reproduction or a fast-backward reproduction.

According to the data reproduction apparatus, the dummy data have a data size which is equal to or greater than a size of one frame defined in standards of the compressed audio data.

According to the data reproduction apparatus, the dummy data have an arbitrary character string.

### Advantage of the Invention

According to a data reproduction method and a data reproduction apparatus of the present invention, it is possible to completely avoid occurrence of noise during specific reproduction of compressed audio data read from a recording medium, which would otherwise be caused by boundary data obtained by concatenating data discontinuously read from the recording medium.

### BRIEF DESCRIPTION OF THE DRAWINGS

FIG. 1 is a diagram showing a structure of reproduction data employed when a data reproduction apparatus of an embodiment of the present invention performs specific reproduction.

FIG. 2 is a diagram showing an example structure of the data reproduced by the data reproduction apparatus of the embodiment of the present invention.

FIG. 3 is a table showing results of calculation of frame sizes compliant with MP3 standards.

FIG. 4 is a diagram showing a data structure of MP3 audio data.

FIG. 5 is a diagram for explaining a structure of reproduction data employed when a related art data reproduction apparatus performs specific reproduction of MP3 audio data.

FIG. 6 is a diagram showing example boundary data that is not determined as error data at an area where data extracted on a per-sector basis are concatenated.

FIGS. 7 (a) and 7 (b) are diagrams for explaining a structure of boundary data where noise occurs when specific reproduction is performed by a related art data reproduction apparatus.

### MODE FOR IMPLEMENTING THE INVENTION

An embodiment of the present invention is hereunder described by reference to the drawings. “Specific reproduction” described in the present embodiment signifies fast-forward reproduction and fast-backward reproduction, such as double-speed reproduction and so on.

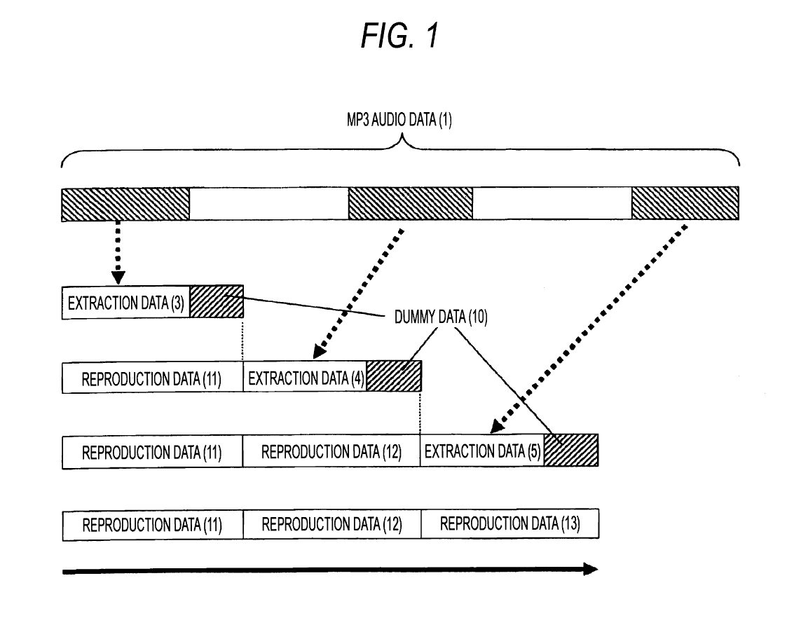

FIG. 1 is a diagram showing a structure of reproduction data employed when a data reproduction apparatus of an embodiment of the present invention performs specific reproduction. As shown in FIG. 1, when the data reproduction apparatus of the present embodiment performs specific reproduction of MP3 audio data 1, the data reproduction apparatus extracts data, at given intervals and on a per-sector basis, from the MP3 audio data 1 configured by a set of frames. In the embodiment shown in FIG. 1, data are extracted from the MP3 audio data 1 in sequence of extraction data 3, extraction data 4, and extraction data 5. Further, after concatenating dummy data 10 to a tail end of each of the extracted data, the data reproduction apparatus concatenates the sets of the extracted data to generate reproduction data 11, 12, and 13. Therefore, the dummy data 10 are inserted into boundary data between the sets of data to be reproduced by the data reproduction apparatus of the present embodiment as the specific reproduction.

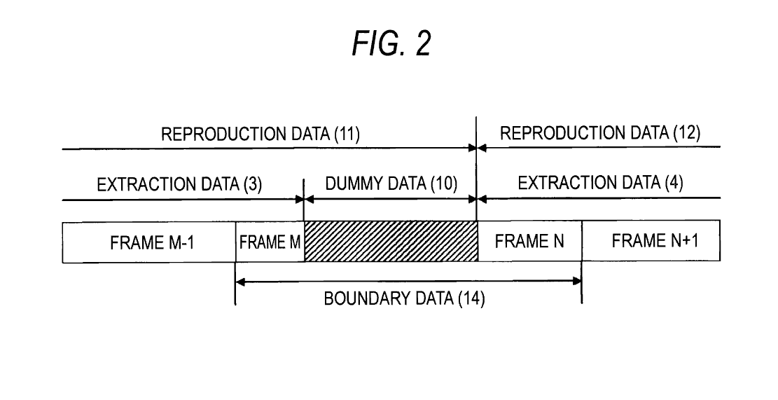

FIG. 2 is a diagram showing an example structure of data reproduced by the data reproduction apparatus of the embodiment of the present invention. As shown in FIG. 2, when a frame M of the extraction data 3 is concatenated to a frame N of the extraction data 4, the dummy data 10 is concatenated to the frame M. Therefore boundary data 14 is configured by concatenating the frame M, the dummy data 10 and the frame N.

The dummy data 10 are a data sequence having a character string 0x00 and assume, as a data size, a frame size of the dummy data 10 is the maximum size defined in the MP3 audio standards. The frame size of the MP3 audio data can be calculated from an MPEG format, a bitrate, and a sampling frequency.

A formula for calculating the frame size is provided below.

Frame size of MPEG1=144×bitrate/sampling frequency

Frame size of MPEG2 LSF=72×bitrate/sampling frequency

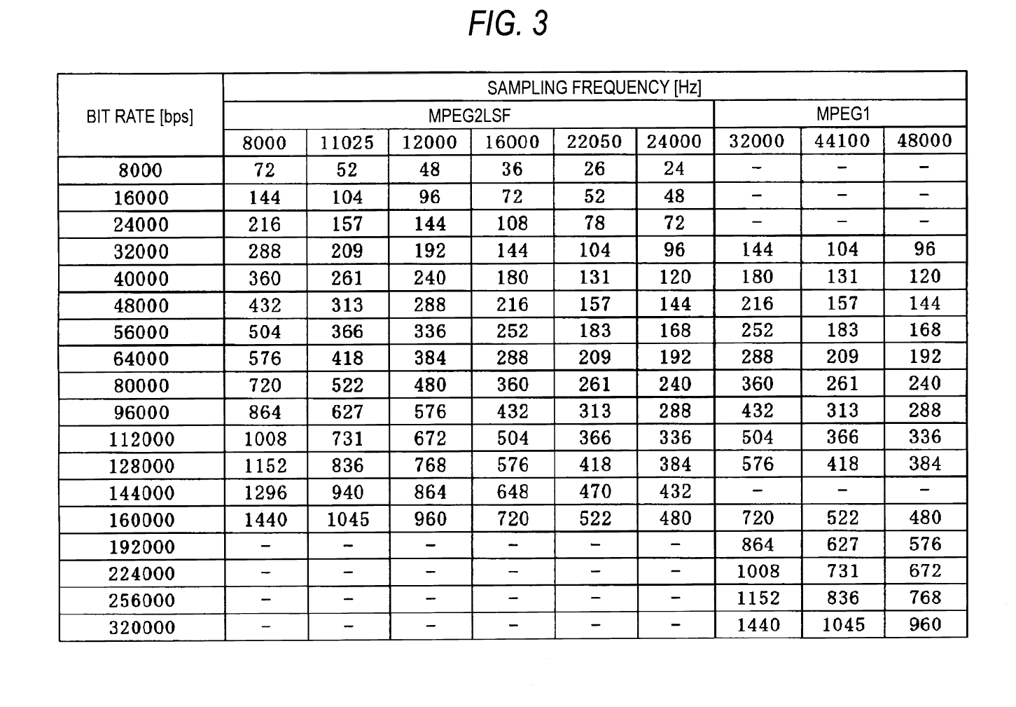

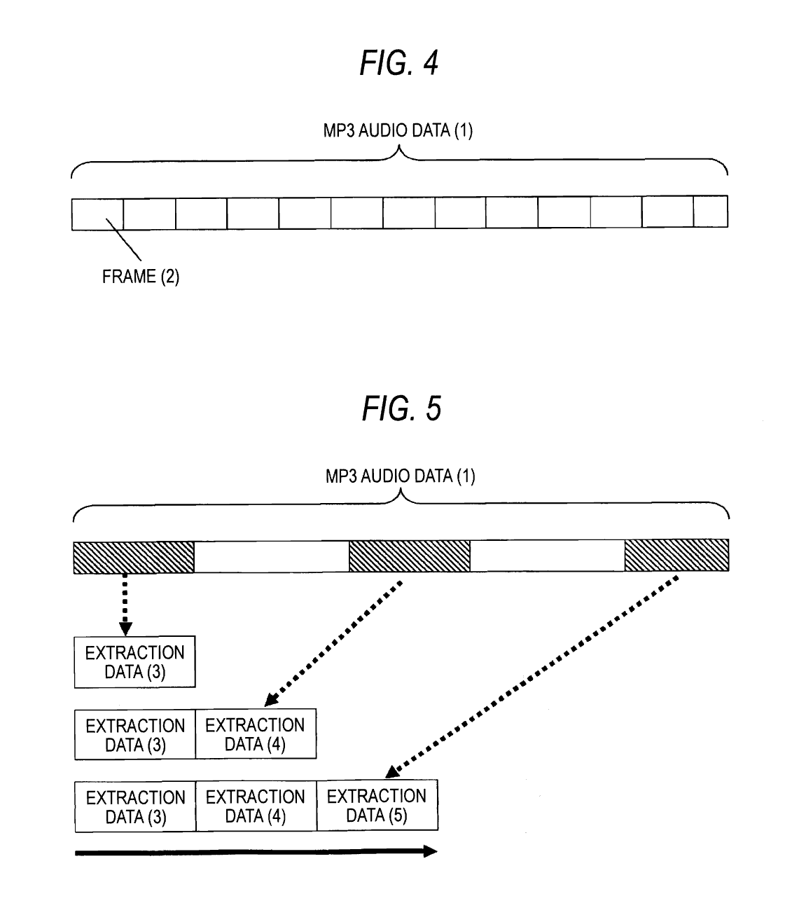

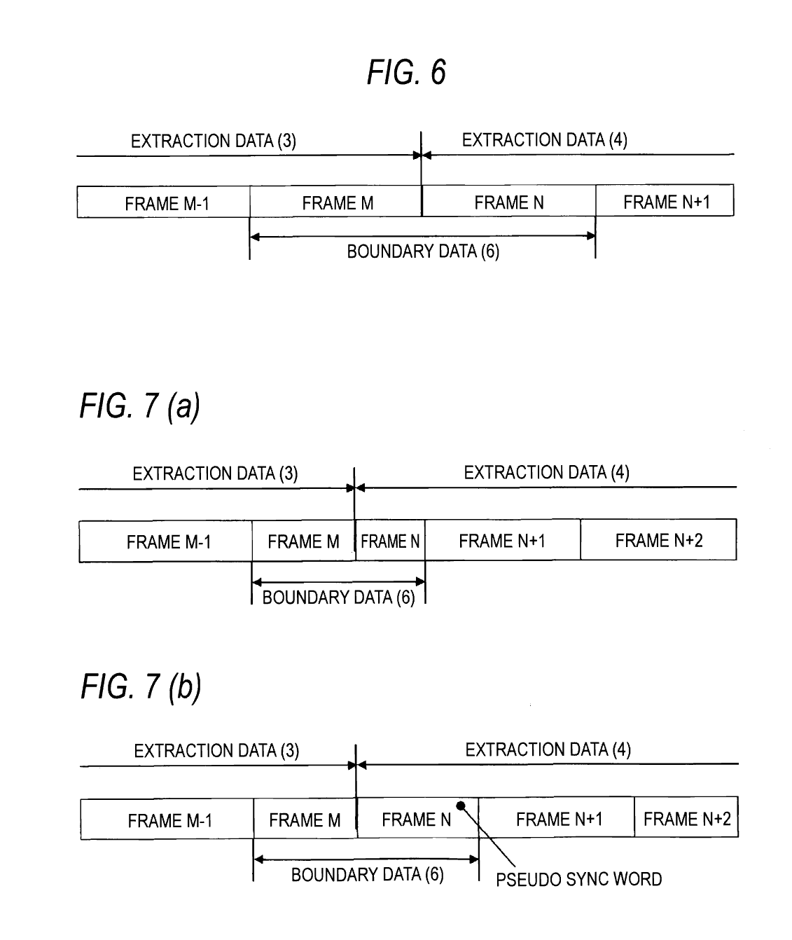

FIG. 3 is a table showing frame sizes compliant with the MP3 standards calculated by the calculation formula. A unit of the bitrate shown in FIG. 3 is [bps], and a unit of the sampling frequency is [Hz]. It is seen from FIG. 3 that 1440 bytes are the maximum frame size of the MP3 audio standards.

By reference to FIG. 1, there is described a method for reproducing data when the data reproduction apparatus of the present embodiment performs specific reproduction. A data reading unit provided in the data reproduction apparatus reads the extraction data 3, on a per-sector basis, from the MP3 audio data 1 recorded in a recording medium, such as an optical disc. Next, a data insertion unit provided in the data reproduction apparatus concatenates the dummy data 10 to the read extraction data 3 to generate reproduction data 11. Subsequently, the data reading unit further performs skip reading of data on a per-sector basis, thereby reading the extraction data 4. The data insertion unit concatenates the dummy data 10 to the extraction data 4, as in the case of the extraction data 3, thereby generating the reproduction data 12. The data reading unit further performs skip reading of data on a per-sector basis, thereby reading the extraction data 5. The data insertion unit concatenates the dummy data 10 to the extraction data 5 as in the case of the extraction data 3 and 4, thereby generating reproduction data 13.

As mentioned above, the data reproduction apparatus sequentially iterates data extraction processing, processing for concatenating the dummy data 10, and processing for skip reading of data. As a consequence, the dummy data 10 are inevitably inserted into the boundary data between the sets of reproduction data.

As mentioned above, according to the data reproduction apparatus and the data reproduction method of the present embodiment, when the MP3 audio data are subjected to specific reproduction, the dummy data having the maximum data size of the standards are inserted into the boundary data. Therefore, the data size of the boundary data does not match the size of one frame. Consequently, the boundary data obtained by concatenating data which are discontinuously read from recording data can be detected as an error, so that occurrence of noise, which would caused by reproduction of boundary data, can be avoided. Therefore, high grade reproduction can be accomplished.

For instance, if the data size of the dummy data 10 inserted between the extraction data is set to 1440 bytes that are the maximum frame size of the MP3 stream standards, it is possible to avoid occurrence of noise during specific reproduction of the MP3 audio data compliant with the standards, regardless of a constant bitrate and a variable bitrate. When the MP3 audio data having a constant bitrate are subjected to specific reproduction, a frame size conforming to the MP3 audio data to be reproduced can also be used.

The dummy data 10 are not limited to a data sequence consisting of a character string 0x00. Any arbitrary character string data can also be used, so long as the character string data do not coincide with a sync word existing in the frame of the MP3 stream. In any event, it is possible to avoid accidental detection of a sync word during reproduction of boundary data obtained by a discontinuous concatenation process in a retrieving a sync word of the next frame.

Reproducing procedures of the data reproduction method employed by the data reproduction apparatus of the present embodiment can be implemented by software and stored in a recording medium in the form of a computer program.

Although the present invention has been described in detail and by reference to a specific embodiment, it is apparent to those skilled in the art that the present invention will be susceptible to various alterations or modifications without departing the spirit and scope of the present invention.

The present patent application is based on Japanese Patent Application (Japanese Patent Application No. 2008-150699) filed on Jun. 9, 2008, the subject matters of which are incorporated herein by reference.

### INDUSTRIAL APPLICABILITY

The data reproduction method and the data reproduction apparatus of the present invention are useful as a reproduction apparatus, a reproduction method, and the like, for subjecting compressed audio data to specific reproduction.

### DESCRIPTIONS OF THE REFERENCE NUMERALS

1 MP3 AUDIO DATA
2 FRAME
3 TO 5 EXTRACTION DATA
6 BOUNDARY DATA
10 DUMMY DATA
11 TO 13 REPRODUCTION DATA
14 BOUNDARY DATA

1. A data reproduction method, comprising:
reading compressed audio data recorded in a recording medium discontinuously;
inserting dummy data between the read compressed audio data;
concatenating the dummy data and the read compressed audio data to generate data; and
performing specific reproduction of the generated data.

2. The data reproduction method according to claim 1, wherein the specific reproduction is a fast-forward reproduction or a fast-backward reproduction.

3. The data reproduction method according to claim 1, wherein the dummy data have a data size which is equal to or greater than a size of one frame in standards of the compressed audio data.

4. The data reproduction method according to claim 1, wherein the dummy data have an arbitrary character string.

5. A data reproduction apparatus comprising:
a data reading unit configured to read compressed audio data recorded in a recording medium; and
a data insertion unit configured to insert dummy data between data to be concatenated and reproduces the data when performing a specific reproduction of data obtained by concatenating the data which are discontinuously read from the recording medium.

6. The data reproduction apparatus according to claim 5, wherein the specific reproduction is a fast-forward reproduction or a fast-backward reproduction.

7. The data reproduction apparatus according to claim 5, wherein the dummy data have a data size which is equal to or greater than a size of one frame defined in standards of the compressed audio data.

8. The data reproduction apparatus according to claim 5, wherein the dummy data have an arbitrary character string.
